(19) United States
(12) Patent Application Publication
(10) Pub. No.: US 2014/0012779 A1
(43) Pub. Date: Jan. 9, 2014

(54) COMMUNICATION AND PROCESSING SYSTEM FOR DERIVATIVE

(71) Applicants: Raymond R. May, Matthews, NC (US); Gary Soloman, Wilmington, NC (US); John Cornelius, Wilmington, NC (US)

(72) Inventors: Raymond R. May, Matthews, NC (US); Gary Soloman, Wilmington, NC (US); John Cornelius, Wilmington, NC (US)

(21) Appl. No.: 13/817,463

(22) PCT Filed: Aug. 18, 2011
(86) PCT No.: PCT/US11/48273

§ 371 Date: Sep. 3, 2013

Related U.S. Application Data
(60) Provisional application No. 61/374,681, filed on Aug. 18, 2010.

(51) Int. Cl. G06Q 40/04

(52) U.S. Cl. CPC G06Q 40/04
USPC 705/36 R; 705/37

(57) ABSTRACT

A method of facilitating trades of mismatch swaps including receiving trade data characterization a plurality of swap trades. Mismatches in at least two of the swap trades are identified and the mismatches are communicated to a plurality of traders. Offsetting mismatches may be identified and communicated to the plurality of traders also. The method may also include receiving offsetting mismatch trade requests from traders and communicating the offsetting mismatch trade requests to a clearinghouse. Identifying the offsetting mismatches may include determining a date gap between standard tenor instruments. And, the method may include determining whether the date gap is within a range of dates selected by a trader. The date gap will likely, in this instance, not be a benchmark tenor.

### CROSS-REFERENCE TO RELATED APPLICATION

This application claims the benefit of U.S. Provisional Application Ser. No. 61/374,681 filed Aug. 18, 2010 which is hereby incorporated by reference in its entirety.

### FIELD OF THE INVENTION

This invention relates to exchange trading platforms and, more particularly, a derivatives trading system for matching counterparties wanting to offset derivative positions.

### BACKGROUND OF THE INVENTION

Until the passage of the Dodds-Frank Act (“DFA”), the majority of all over-the-counter (“OTC”) derivatives (defined by the DFA as a “swap”) were traded bi-laterally between two parties using standard legal contracts called international swaps and derivatives association (“ISDA”) agreements and credit support annex (“CSA”) agreements. In this environment the contracts stayed in place unless the two parties agreed to terminate the agreement by mutually agreeing an unwind price. As a result portfolios of deals tended grow and grow. Managing the large portfolios of bi-lateral portfolios produce many risk management problems.

With the introduction of the DFA, the majority of derivatives trades will be conducted electronically and cleared through central clearing houses. The result of this is to create a situation that the respective credit name or quality of two parties will no longer be relevant to the price of the initial transaction or the ongoing management of the credit profile. Instead all trades cleared through the same clearing house will in effect become fungible.

The advantages of this system include freedom from concerns about credit risk and increased anonymity. Trades entered into by two parties no longer need to know the details of the other party and trading can be done anonymously.

A technical problem arises, however, as to how to efficiently and effectively communicate and execute the trades over distributed electronic networks of interconnected computer systems. Another technical problem is to overcome the limitations on information communicated between these parties now that they're forced to adhere to the standards set by the trading platforms. Previously, in OTC trading, parties were free to vary terms of the trade to fit their individual circumstances and needs. After the DFA, trading data exchanged between market participants will be in standardized formats that inhibit the flexibility of transactions.

Improvements are desired in flexibility of communicating and processing derivatives trades in a post-DFA environment.

### SUMMARY OF THE INVENTION

A method of facilitating trades of mismatch swaps including receiving trade data characterization a plurality of swap trades. Mismatches in at least two of the swap trades are identified and the mismatches are communicated to a plurality of traders. Offsetting mismatches may be identified and communicated to the plurality of traders also.

The method may also include receiving offsetting mismatch trade requests from traders and communicating the offsetting mismatch trade requests to a clearinghouse. Identifying the offsetting mismatches may include determining a date gap between standard tenor instruments. And, the method may include determining whether the date gap is within a range of dates selected by a trader. The date gap will likely, in this instance, not be a benchmark tenor.

In addition, the method may include determining a residual risk of the mismatches and communicating the residual risk to one of the traders.

Also, the method may include determining a valuation of the offsetting mismatches and communicating the valuation to the traders.

Mismatches may be identified between pairs of swaps or chains of instruments in a portfolio, such as at the end of a day of trading by a trader.

The method may include receiving bids for the offsetting mismatches from the traders and executing the best bids. Or, the method could include conducting an auction for the offsetting mismatches. The method could also include facilitating bidding or auction by generating a swap curve and communicating the swap curve to the traders. The swap curve could also be used to price the offsetting mismatches. Regardless of how trades are selected, the winning bids could be submitted for clearing.

Offsetting mismatches could also be determining using maturity dates wherein the swaps have differing tenors. Such swaps may have instruments with start dates in the past, for example.

For the purpose of shifting positions from one clearing house to another, mismatches could be determined by finding pairs equal, but opposite trades between two counterparties on the same two clearing houses.

The methods above could also be embodied in various processes and systems, including computer systems or computer program products.

### BRIEF DESCRIPTION OF THE DRAWINGS

FIG. 1 is a flow chart of an offset model system of one embodiment of the present invention;

FIG. 2 is a system diagram of an offset model system of another embodiment of the present invention;

FIG. 3 is a system diagram of an offset model system of another embodiment of the present invention;

FIG. 4 is a screen shot of a trading screen for standardized swaps of an embodiment of the present invention;

FIG. 5 is a dataset used to match offsetting mismatches between pairs of instruments by the offset model of another embodiment of the present invention;

FIG. 6 is a screen shot of a trader GUI that identifies mismatched pairs for offset matching with other traders of another embodiment of the present invention;

FIGS. 7-9 are schematics of matched offsetting mismatches of a range of tenors and multiple parties of other embodiments of the present invention;

FIG. 10 is a flow diagram of an auction style offset matching system of another embodiment of the present invention; and

FIG. 11 is a flow diagram of an RFP style offset matching system of another embodiment of the present invention.

### DETAILED DESCRIPTION OF THE INVENTION

The present invention now will be described more fully hereinafter with reference to specific embodiments of the invention. Indeed, the invention can be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise. The term “comprising” and variations thereof as used herein is used synonymously with the term “including” and variations thereof and are open, non-limiting terms.

After passage of the DFA, the inventors anticipate a problem of traders being forced to trade in instruments of fixed tenors (e.g., n years, wherein n is an integer) on different start dates, making precise hedging of current positions more difficult. For example, if a 1 year instrument buy is hedged the next day with a 1 year sell, the one day lag represents a residual exposure in the mismatch between the two maturity dates. Since clearinghouses and exchanges are ill-equipped to handle non-standard contracts, traders are left unable to hedge these mismatches of a small number of days. Also, unlike trading prior to the DFA, parties on the exchanges are anonymous and disconnected after clearing and therefore unable to unwind their positions with each other to neutralize the mismatches. Embodiments of the present invention address this problem by identifying the residual mismatches of one trader between pairs (or three, or more) instruments and finding offsetting mismatches in pairs (or three, or more) instruments of another trader. These offsetting mismatches can then be passed through for processing and clearance, neutralizing the residual risk of the mismatch.

Clearing of trades across different clearing houses also presents issues. Before clearing, all swaps had the same financial profile, no matter what counterparty you traded it with. In other words all swaps were fungible. Given the way different clearing houses represent swaps internally, and the fact that they use different models to calculate margin requirements, a swap traded through one clearing house does not have the exact same risk profile as the same swap trading at another clearing house. Counterparties will likely transact across multiple clearing houses because they will gravitate toward whichever one has the best price at the time of the trade.

Margin calculations are based on the net position in a particular clearing house. For example, buying $100 million in a 2 YR swaps and selling $100 million of the same swap (on the same clearing house) would result in a net-zero position and little or no margin requirement. If these trades were done at different clearing houses, the counterparty would have margin obligations for both trades, requiring an outlay of capital. In this situation it would be more desirable to have both of these trades booked at the same clearing house.

Embodiments of this invention address this issue by finding counterparties with the same position in different clearing houses who wish to switch their positions to another clearing house. When a match is found the two traders could effectively exchange positions, resulting in their trade being moved from one clearing house to another. By finding someone with the opposite positions (i.e., having done opposite trades at the same two clear houses), it is possible to buy the contract that you previously sold on clearing house A and sell the contract you previously bought on clearing house B with the opposing counterparty. The result is having a net zero position at both clearing houses. The same mechanics can be used to simply shift positions from one clearing house to another. Being able to shift positions from one clearing house to another essentially makes cleared swaps fungible as they are without clearing.

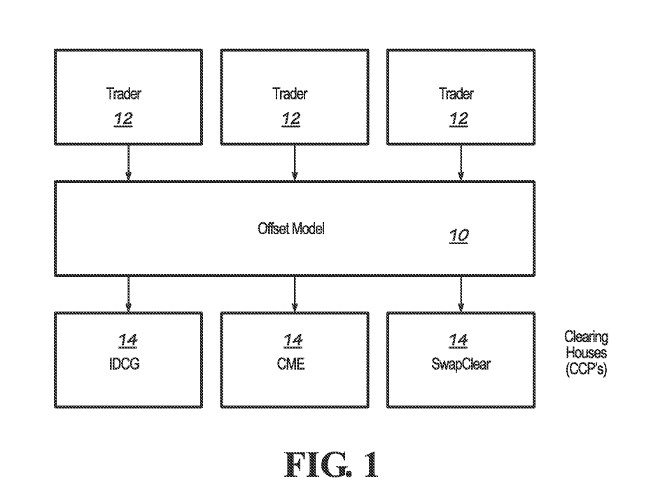

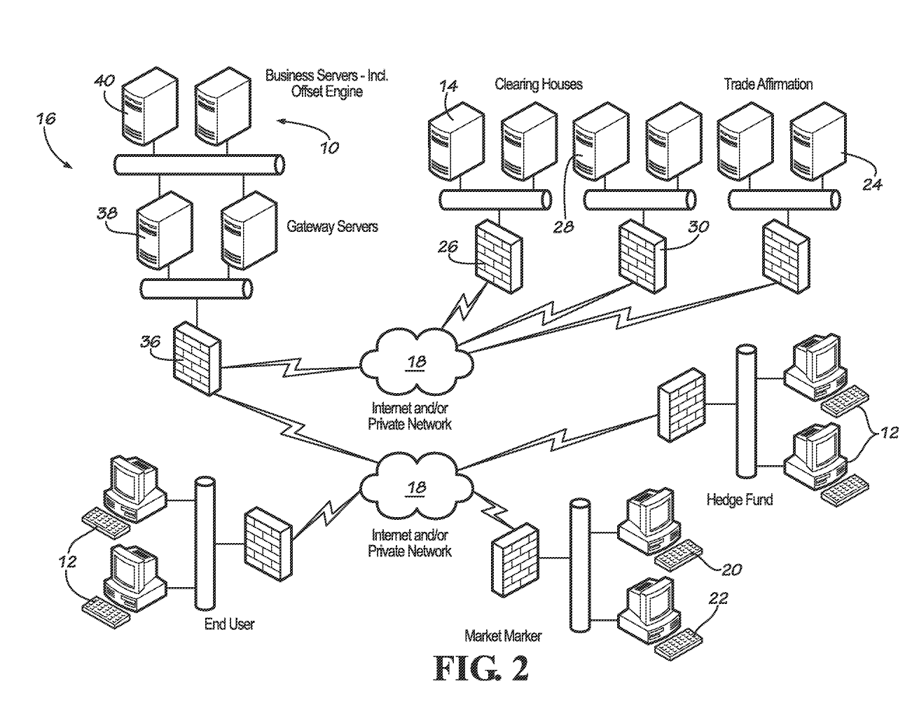

In one embodiment for example, as shown in FIG. 1, the present invention includes an offset matching system 10 for collecting derivative portfolio data on standardized trades from traders 12, processing the data to identify mismatches in the portfolio data, and communicate offsetting mismatches in the portfolio data to traders and then communicating mismatch trades to different clearinghouses 14 for settlement. For example, in an embodiment shown in FIG. 2, the invention includes a communication and processing system 16 that includes the traders 12 connected via a network 18 to a plurality of banks 20, a plurality of brokers 22, clearinghouses 14, a derivatives processing entity 24 through an offset model system 10.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIG. 2, the traders 12, banks 20 and brokers 22 are all end users that are trading over client terminals linked via message gateways over the network 18 to the offset model system 10. The client terminals, as described above, can be a range of computer or other electronic systems, including personal computers, mainframes or more customized systems configured to communicate, receive and display trading data for derivatives and other instruments between the traders 12, banks 20 and brokers 22 and the offset model system 10, clearinghouses 14 and the processing entity 24.

The network 18 is represented in FIG. 2 generally as a single cloud but can include different individual and combined systems of interconnection for communication between the parties. For example, the network 18 may be the internet, a wireless network or a local-area-network (“LAN”) or combinations of all three.

The clearinghouses 14 are centralized entities configured to receive information on trades and then intervene between the entities as a trusted intermediary to reduce counterparty risk. Although the trades are agreed to between various traders (such as traders 12, banks 20 and brokers 22), each of those entities after clearing becomes a counterparty to the clearinghouse 14. The clearinghouse systems, then, are configured to break data on a single trade into two mutually opposing information datasets representing two mutually opposing contracts. Each of those contracts is with the clearinghouse itself, eliminating the counterparty with which the original agreement was made.

The derivatives processing entity 24 is configured to provide general post-trading processing and workflow for derivatives contracts, often in communication with the clearinghouses 14. Each of the clearinghouses 14 and processing entity 24 include a firewall 26 for security since they contain sensitive, confidential financial information and various servers 28 for performing their functional processing of the trading data received through the network 18.

As shown in FIG. 2, the offset model system 10 of an embodiment of the present invention is an electronic trading system that is implemented on a plurality of matching engine servers 40 behind a firewall 36 and communicates via a plurality of messaging gateways 38. The firewall 36, similar to the other firewalls 30, is configured to guard confidential information and mediate access to and from the matching engine servers 40 upon which is stored sensitive, confidential information. The messaging gateways 38 are hardware or software that are configured to convert messaging protocols between the matching engine servers 40 and the protocols needed for the various configurations of network 18 and with the clearinghouses 14 and the different traders 12, 20, 22.

The matching engine servers 40 of an embodiment of the present invention are configured with a plurality of computer modules for executing functions including matching bid and offers, storing order books, instrument definitions, permissions, trade data, analytical models, current market prices, customer and trade databases, an API for linking to the clearinghouses 14 and the offset model system 10 which has the functions described hereinbelow.

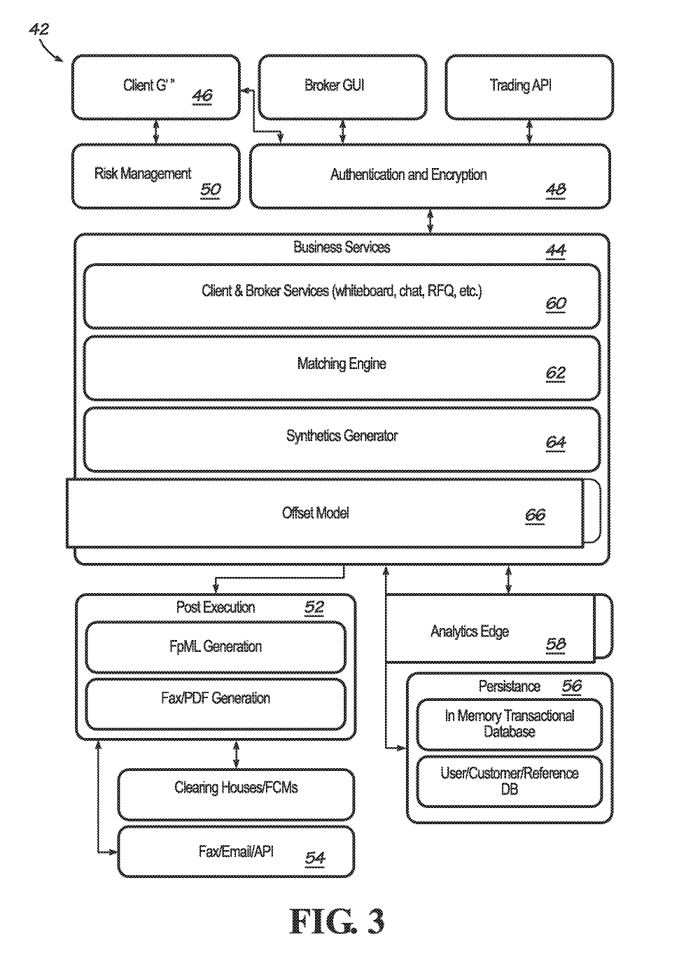

As shown in FIG. 3, another embodiment of the invention includes an entire swap execution facility 42 that includes a business service system 44 that communicates with various trader GUI's 46 through a front end system that includes authentication and encryption modules 48 and a risk management module 50. The business service 44 is also configured to communicate with backend systems that include a post-execution module 52 that intermediates with clearinghouses 14 via an API 54, a database 56 and an analytical edge module 58.

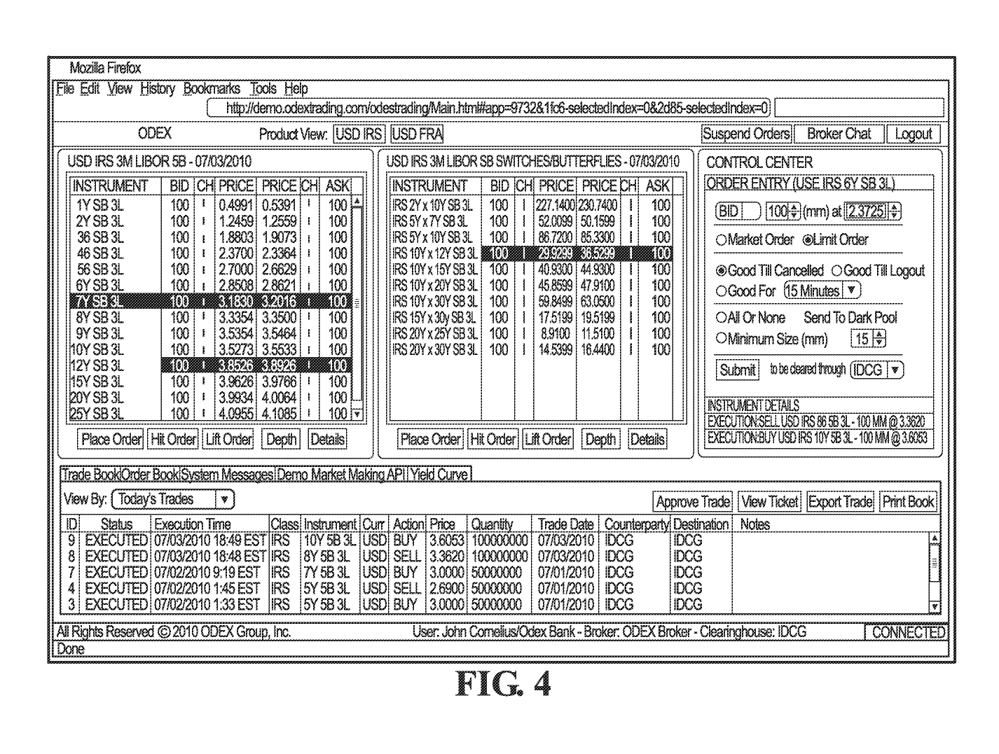

The trader GUI's 46 are configured to allow interface with the business service system 44 by the various traders including individual traders 12, banks 20 and brokers 22. An exemplary embodiment of such a GUI is shown in FIG. 4, which is configured to allow users to post prices and execute transactions on standardized tenor trades in the post-DFA environment. The GUI shows a benchmark tenor trading screen of interest rate swaps clearing through a clearinghouse 14. To reduce the complexity of locating mismatches, the GUI allows the user to select a range of dates to consider when locating them. The GUI also is configured to communicate with the risk management module 50 which includes components of the offset model system 10, such as a mismatch position identifier that calls the residual risk of mismatching pairs of hedged positions to the attention of the traders.

Regardless of the operations being performed, the GUI preferably communicates through the authentication and encryption modules 48 that ensure secure communication between the business service system 44 and the traders.

Returning to FIG. 3, the business services system 44 includes a combination of functional modules facilitating services, such as client and brokerage services 60, a matching engine module 62, a synthetics generator module 64, and an offset model module 66.

The client and brokerage services 60 include communications functions such as user-to-user chat, request for quote (RFQ) and a whiteboard to host non-tradable intent to trade prices. Also, the services 60 may include back loading of transactions that were executed in another medium, such as OTC derivatives traded prior to the DFA and which are now being cleared by the clearinghouses under the DFA, and having mismatched pairs of swaps that need to be offset with mismatches of other parties.

The synthetics generator module 64 is configured to generate spread trade of a buy and a sell of two duration weighted instruments. For example, a 2 year swap can be traded against a 5 year swap wherein the years are weighted and a price difference determined between the two. This enables trading of instruments of two different durations. The module 64 continuously calculates the duration of all instruments, posting the best bid or ask based on the respective markets in the underlying instrument and (also) allowing direct bids or offers for the synthetic spread if a 2 year and 5 year instrument are to be swapped. The matching engine module 62 is configured to operate order books of live, tradeable bids and asks, and manual and automatic matching of trades, which are then passed through post execution module 52 for clearing. Notably, the matching engine module 62 can process trades by parties of offsetting mismatches (as a component of the offset model system 10) as well as conventional swap trades.

The offset model module 66 (as a component of the offset model system 10) is configured to enable trading for a pair of dates, or multiple dates, that are close together and are not benchmark tenors that could otherwise be traded on a conventional exchange. For example, this could be performed in a separate auction or on a separate offset trading screen on the trader GUI's 46. Additional details of the functions of various embodiments of the offset model module 66 are described hereinbelow.

The analytic edge module 58 is configured to calculate the current market price (e.g., using the yield curve) of all market tradable instruments to allow accurate valuation of offset possibilities by the offset module 66. And, the module 58 is further configured to indicate the current price at which such trades could or should be executed to be fair to both parties.

The database 56 represents a persistence layer configured for receipt and long-term storage of all dates, transactions, tradeable instruments, instruments that have traded, historical price information, customer data/permissions, current prices, order books, etc. to facilitate operation of the remaining swap execution facility 42.

The post-execution module 52 is configured to receive trade data from the business service system 44 and convert the executed trade into a standard mark up format, such as FpML. This converted trade is then passed (preferably automatically) to the clearinghouses 14, such as through the API 54 hosted by the clearinghouses, and through the traders own systems. Other modes of data communication may be used, such as e-mail, fax and/or pdf generation.

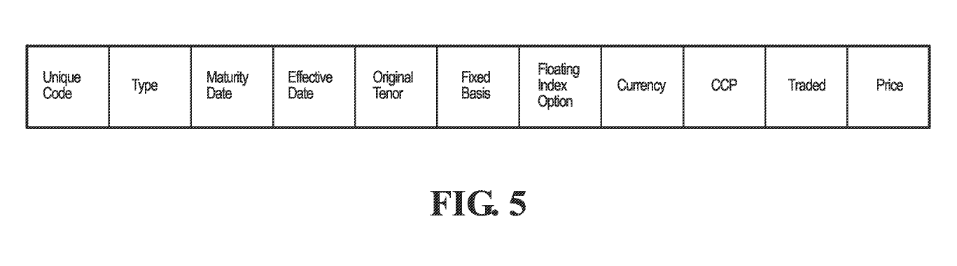

Embodiments of the offset model system 10 of the present invention are represented symbolically in both FIGS. 1 and 3. Regardless of where it is resident, the offset model of one embodiment of the present invention is configured to receive trade data from multiple traders 12, 20, 22 in the form shown in FIG. 5, wherein each instrument is defined by a dataset including a string of data paired with a unique code, including an instrument type, maturity date, effective date, original tenor, fixed basis, floating index option, currency, CCP (clearinghouse), a traded indicator and a price.

The DFA defines many types of swaps including, for example, interest rate swaps, caps, forward-rate-agreements (FRA). However, these all share some commercial terms that enable matching by the offset model 66. For example, primary commercial terms may include the maturity date, this is the date that the contract is complete, which usually is a valid business date for the respective currency. The effective date is the date the contract starts, which usually is a valid business date for the currency. For example, for normal contracts this may be 2 business days beyond the trade date unless it is a forward starting contract. Although clearing houses will allow almost any date combinations to clear the normal dates traded on open exchanges will be standard tenors of n-years, such as 1, 2 or 3 years. This original benchmark is stored in the string as the original tenor.

The fixed basis is the manner in which fixed payments are paid normally semi-annual on a 30/360 month/year basis or A/360, which is the actual number of days over 30 day months. The floating rate index defines the manner in which floating payments are calculated and against which index—for example 3 month Libor, 1 month Libor or other indices. Swaps trade in all currencies and therefore the currency is an important part of the dataset. The CCP defines the central clearing party for the original transaction, which is expected to be several different entities, each (possibly) with its own definitions for a standard transaction. The previously traded field “traded” is indicated by a Y or N, wherein Y indicates previously traded and therefore capable of being offset matched and executed. The fields listed in FIG. 5 may be back loaded by a trader as many trades may have already been executed on another platform. Thus, the fields of FIG. 5 may be embodied by a separate input interface.

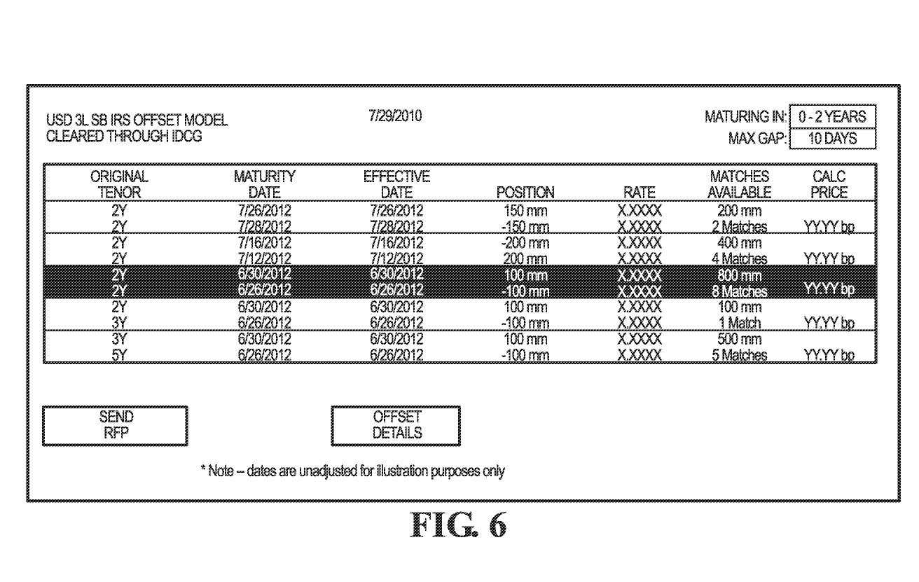

In one embodiment, the offset model 66 is configured use the data set or string shown in FIG. 5 to find possible matches, generate indicative pricing and to post interest in the offset trading screen on the GUI's 46. As shown in FIG. 6, for example, is a screen for identifying mismatched pairs for possible offset matching. In a first step, all traders indicate on their trade blotter which positions they'd like to offset with opposite mismatches of other traders. The offset model 66 determines the mismatches in pairs of instruments and compares those to the mismatches of other traders, identifying “matches” that are offsetting mismatches of other trader pairs or groups of instruments. The first trader selects a pair of trades with a mismatch and sends out a request for price (RFP) to all traders with groups of trades having mismatches that they wish to offset. The RFP recipients are shown a price calculated, for example, by the analytical edge module 58 and the pair of swaps in their book that offsets the request. The RFP recipient can respond with the price at which they're willing to trade their pair of swaps. The matching engine servers 40 can then execute at the best price.

Pricing could also be determined by timed auctions that match the best bids and asks for offsetting mismatches.

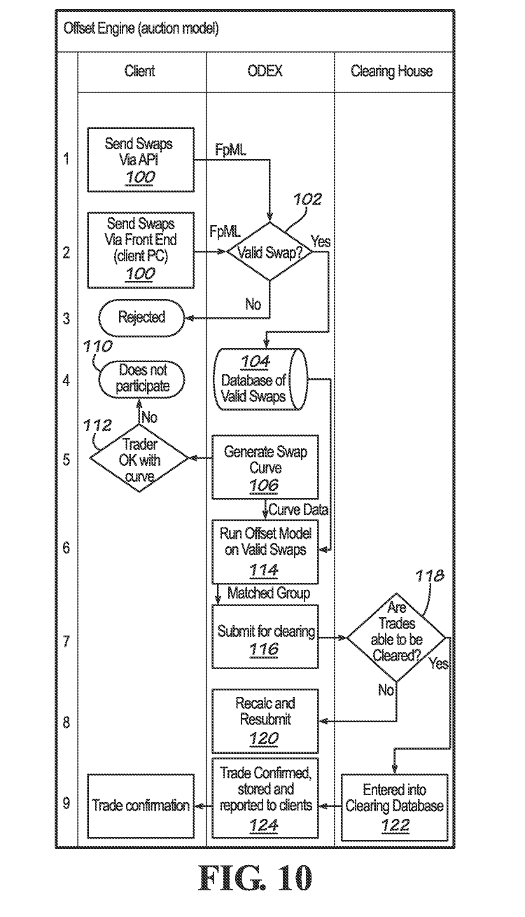

For example, in another embodiment, the present invention includes a process for directing communications between a client, a trading platform and a clearing house in a manner to facilitate trades of offsetting mismatch positions, as shown in FIG. 10. In a first step 100, swaps are sent to the trading platform by API or directly from the front end system using recognizable formatting, such as FpML (financial product markup language). In another step 102, a validation check is performed to ensure that the swap is eligible for the offset process. This process will check the validity of the trade and also make sure it falls within certain bounds set for the particular auction such as maturity date, maximum gap in maturity dates, such as 1 through 5 days, currency and fixed basis as well as for the validity of the transmitted message itself. If it's not a valid swap, it is rejected. If it is a valid swap, or swap pair, or swap strings with some long and some short, it's entered 104 into a database for later processing by the trading platform.

Prior to the auction, a swap curve is generated and distributed 106 to all the clients participating in the offset run. At this point, a client can decide 112 not to participate 110 based on the results of the swap curve generated. The swap curve data is also communicated to the offset model for use in the auction process.

In another step 114, the offset model is run to determine the best matches for execution of trades. The received curve data is used to price each of these trades. The matched group of trades is then submitted 116 for clearing. In this step, a group of trades representing each match is sent to the clearinghouse. The clearing house responds electronically whether or not the trade is cleared 118 based on their criteria.

If one of the legs of the match cannot be cleared, all trades in the match are allowed to decay and never executed. And, this termination information is passed 120 back to the offset engine for use in generating a new set of matches. The ability to be cleared is determinined by the trading limits set by each counterparty of the trade. These limits are enforced by the clearing houses. Trades that do meet the clearinghouse criteria are confirmed by the clearinghouse and entered 122 into its database. The trade confirmation is received by the trading platform, stored 124 in its database and then reported 124 to the clients.

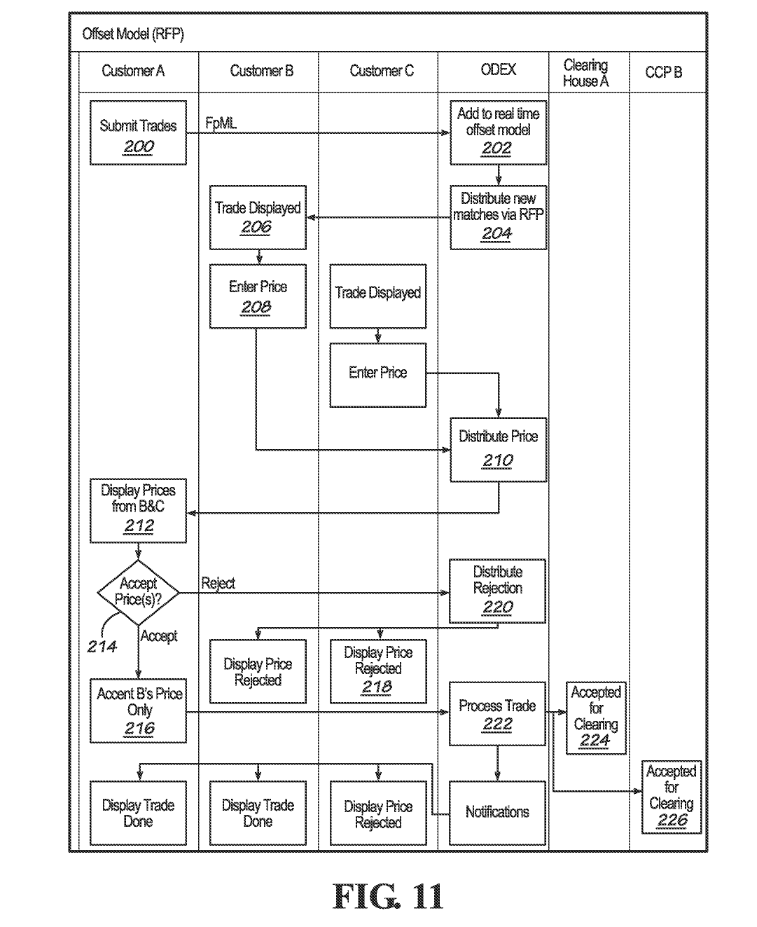

In another embodiment of the present invention, as shown in FIG. 11, the offset model uses RFP to establish matches instead of an auction. It should be noted, though, some embodiments could combine RFP and auctions, or various components of each. Trades are submitted 200 by customers (A, B, C) using FpML or another message format to the trading platform which adds 202 the trades to the real time offset model and distributes 204 new matches via the RFP process. The trade is displayed 206 and Traders B, C enter 208 prices for a trade proposed by trader A. The prices from B and C are distributed 210 and displayed 212. Trader A decides whether to accept 214 either of the proposed prices. Trader A accepts 216 trader B's price and rejects 218 trader C's price. Trader C's rejection is received by the trading platform and distributed 220 to the displays of traders B and C, along with the rejected price.

Trader B's accepted trade is sent to the trading platform which preprocesses 222 the trade and submits it to the clearinghouse for acceptance and settlement 224. Notifications are distributed by the trading platform of the completed trade to each of the participating traders.

The RFP process may also address cross-clearinghouse trades by submitting the trade to another clearinghouse (CCP B) for acceptance and settlement 226. For example, a pair of traders could agree to a swap of a same or similar instrument having a different clearinghouse as the counterparty. An offset of this same swap could be determined by the process and would involve submitting trades to different clearinghouses for acceptance and settlement.

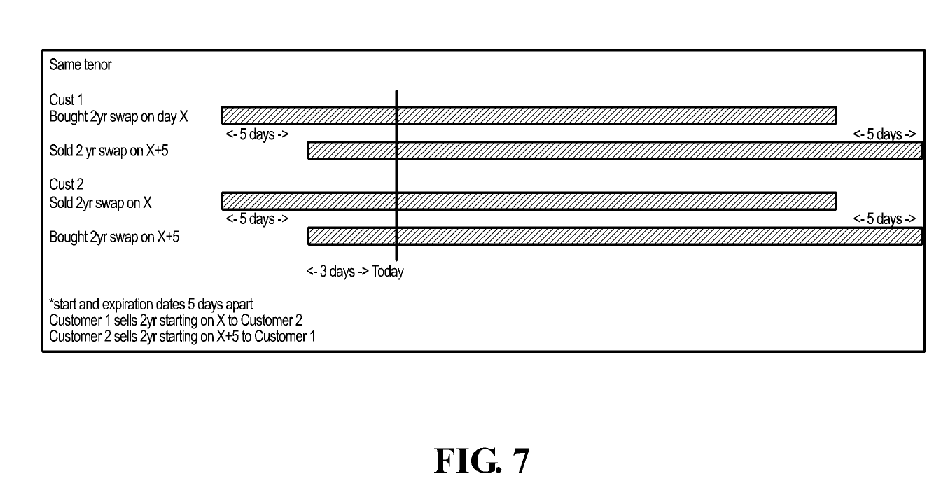

FIG. 7 illustrates an embodiment of the offset model system 10 of the present invention used to identify and trade offsetting mismatches of instruments with the same tenor. In this instance, the instruments are 2 year swaps with a 5 day mismatch between a buy and sell for customer 1 and a 5 day mismatch between the sell and buy for customer 2.

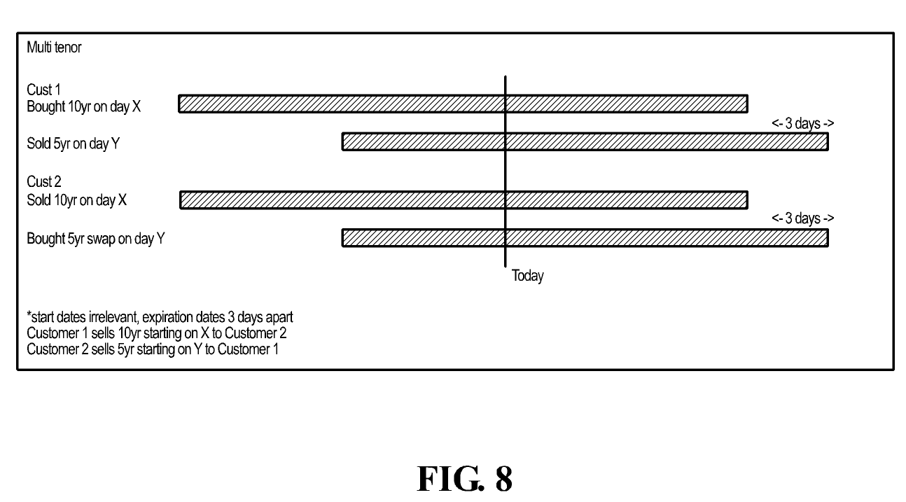

FIG. 8 illustrates another embodiment of the offset model system 10 wherein the pairs have different tenors, each pair having a 10 year and a 5 year. Notably, an important term is the 3 day mismatch at the maturity dates of the swap pairs when the start dates are both in the past.

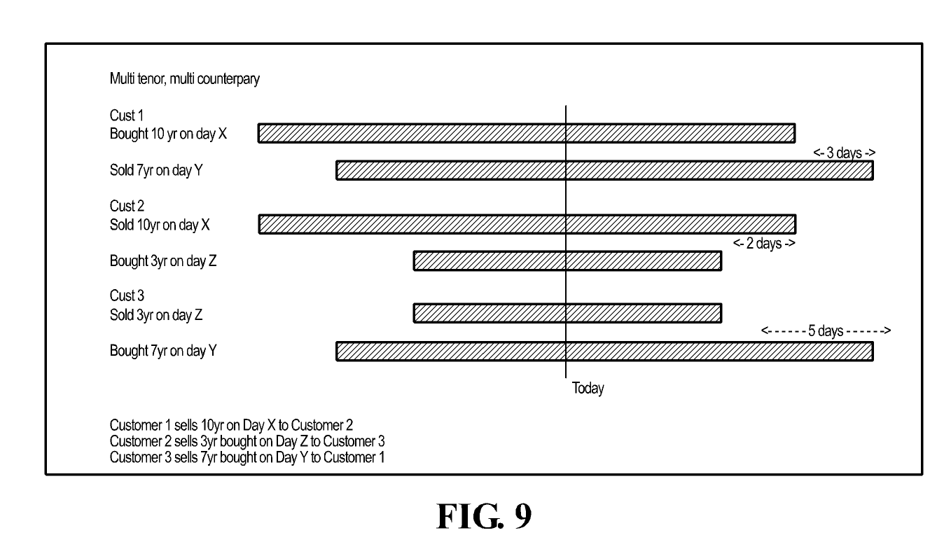

FIG. 9 illustrates another embodiment of the offset model system 10 wherein multiple tenors of multiple counterparties are combined to offset mismatches. Again, the mismatch at the maturity dates are compared until a neutralizing set of mismatches are determined and traded to eliminate residuals. The focus on the maturity dates allows trading of offsetting pairs of different tenors once the effective date has moved into the past. This allows forward starting swaps to “transfer” to the same code as a benchmark of exactly the same terms.

It is envisioned that, unlike standardized instrument trading, that trading of offsetting mismatches would occur on a more occasional basis over longer periods as they are accumulated by various market participants. For example, at the end of a daily trading session for swaps, the offset model system 10 may identify tradable mismatches and send a message to a trader that an offset auction is to occur at some set time (30 minutes) after the trading day ends.

A number of aspects of the systems, devices and methods have been described. Nevertheless, it will be understood that various modifications may be made without departing from the spirit and scope of the disclosure. Accordingly, other aspects are within the scope of the following claims.

That which is claimed:

1. A method of facilitating trades of mismatched swaps, the method comprising:
receiving trade data characterizing a plurality of swap trades;
identifying mismatches in at least two of the swap trades; and
communicating the mismatches to a plurality of traders.

2. A method of claim 1, further comprising identifying offsetting mismatches and communicating the offsetting mismatches to the plurality of traders.

3. A method of claim 2, further comprising receiving offsetting mismatch trade requests from the traders and communicating the offsetting mismatch trade requests to a clearinghouse.

4. A method of claim 3, wherein identifying offsetting mismatches includes determining a maturity date gap between standard tenor instruments.

5. A method of claim 4, further comprising determining whether the date gap is within a range of dates selected by a trader.

6. A method of claim 5, further comprising determining a residual risk of mismatches and communicating the residual risk to one of the traders.

7. A method of claim 6, wherein the date gap is a non-benchmark tenor.

8. A method of claim 7, further comprising determining a valuation of the offsetting mismatches.

9. A method of claim 8, further comprising communicating the valuation to traders.

10. A method of claim 1, wherein identifying mismatches includes identifying mismatches between pairs of swaps.

11. A method of claim 2, further comprising receiving bids for the offsetting mismatches from the traders.

12. A method of claim 11, further comprising executing the best bid.

13. A method of claim 2, further comprising conducting an auction for the offsetting mismatches.

14. A method of claim 13, further comprising generating a swap curve and communicating the swap curve to the traders.

15. A method of claim 14, further comprising pricing the offsetting mismatches using the swap curve.

16. A method of claim 15, further comprising submitting winning bids for clearing.

17. A method of claim 2, wherein the offsetting mismatches are determined using maturity dates and the swaps have differing tenors.

18. A method of claim 17, wherein the swaps have start dates in the past.

19. A method of claim 2, further comprising combining swaps from a plurality of traders to create offsetting mismatches.

20. A method of claim 19, further comprising combining swaps of different tenors to create offsetting mismatches.
